(19) United States
(12) Patent Application Publication
(10) Pub. No.: US 2014/0152558 A1
(43) Pub. Date: Jun. 5, 2014

(54) DIRECT HOLOGRAM MANIPULATION USING IMU

(71) Applicants: Tom Salter, Seattle, WA (US); Ben J. Sugden, Woodinville, WA (US); Daniel Deptford, Redmond, WA (US); Robert L. Crocco, JR., Seattle, WA (US); Brian E. Keane, Bellevue, WA (US); Christopher E. Miles, Seattle, WA (US); Laura K. Massey, Redmond, WA (US); Alex Aben-Athar Kipman, Redmond, WA (US)

(72) Inventors: Tom Salter, Seattle, WA (US); Ben J. Sugden, Woodinville, WA (US); Daniel Deptford, Redmond, WA (US); Robert L. Crocco, JR., Seattle, WA (US); Brian E. Keane, Bellevue, WA (US); Christopher E. Miles, Seattle, WA (US); Laura K. Massey, Redmond, WA (US); Alex Aben-Athar Kipman, Redmond, WA (US)

(21) Appl. No.: 13/691,445

(22) Filed: Nov. 30, 2012

(51) Int. Cl. G09G 5/377; G06F 3/033

(52) U.S. Cl. CPC G09G 5/377; G06F 3/033
USPC 345/157

(57) ABSTRACT

Methods for controlling an augmented reality environment associated with a head-mounted display device (HMD) are described. In some embodiments, a virtual pointer may be displayed to an end user of the HMD and controlled by the end user using motion and/or orientation information associated with a secondary device (e.g., a mobile phone). Using the virtual pointer, the end user may select and manipulate virtual objects within the augmented reality environment, select real-world objects within the augmented reality environment, and/or control a graphical user interface of the HMD. In some cases, the initial position of the virtual pointer within the augmented reality environment may be determined based on a particular direction in which the end user is gazing and/or a particular object at which the end user is currently focusing on or has recently focused on.

### BACKGROUND

Augmented reality (AR) relates to providing an augmented real-world environment where the perception of a real-world environment (or data representing a real-world environment) is augmented or modified with computer-generated virtual data. For example, data representing a real-world environment may be captured in real-time using sensory input devices such as a camera or microphone and augmented with computer-generated virtual data including virtual images and virtual sounds. The virtual data may also include information related to the real-world environment such as a text description associated with a real-world object in the real-world environment. The objects within an AR environment may include real objects (i.e., objects that exist within a particular real-world environment) and virtual objects (i.e., objects that do not exist within the particular real-world environment).

In order to realistically integrate virtual objects into an AR environment, an AR system typically performs several tasks including mapping and localization. Mapping relates to the process of generating a map of a real-world environment. Localization relates to the process of locating a particular point of view or pose relative to the map of the real-world environment. In some cases, an AR system may localize the pose of a mobile device moving within a real-world environment in real-time in order to determine the particular view associated with the mobile device that needs to be augmented as the mobile device moves within the real-world environment.

### SUMMARY

Technology is described for facilitating control of an augmented reality environment associated with a head-mounted display device (HMD). In some embodiments, a virtual pointer may be displayed to an end user of the HMD and controlled by the end user using motion and/or orientation information associated with a secondary device (e.g., a mobile phone). Using the virtual pointer, the end user may select and manipulate virtual objects within the augmented reality environment, select real-world objects within the augmented reality environment, and/or control a graphical user interface of the HMD. In some cases, the initial position of the virtual pointer within the augmented reality environment may be determined based on a particular direction in which the end user is gazing and/or a particular object at which the end user is currently focusing on or has recently focused on.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of one embodiment of a networked computing environment in which the disclosed technology may be practiced.

FIG. 2A depicts one embodiment of a mobile device in communication with a second mobile device.

FIG. 2B depicts one embodiment of a portion of an HMD.

FIG. 2C depicts one embodiment of a portion of an HMD in which gaze vectors extending to a point of gaze are used for aligning a far inter-pupillary distance (IPD).

FIG. 2D depicts one embodiment of a portion of an HMD in which gaze vectors extending to a point of gaze are used for aligning a near inter-pupillary distance (IPD).

FIG. 2E depicts one embodiment of a portion of an HMD with movable display optical systems including gaze detection elements.

FIG. 2F depicts an alternative embodiment of a portion of an HMD with movable display optical systems including gaze detection elements.

FIG. 2G depicts one embodiment of a side view of a portion of an HMD.

FIG. 2H depicts one embodiment of a side view of a portion of an HMD which provides support for a three dimensional adjustment of a microdisplay assembly.

FIG. 3 depicts one embodiment of a computing system including a capture device and computing environment.

FIGS. 4-6 depict various embodiments of various augmented reality environments in which a virtual pointer may be displayed to an end user of an HMD and controlled by the end user using motion and/or orientation information associated with a secondary device.

FIG. 7A is a flowchart describing one embodiment of a method for controlling an augmented reality environment using a secondary device.

FIG. 7B is a flowchart describing one embodiment of a process for determining an initial virtual pointer location.

FIG. 7C is a flowchart describing one embodiment of a process for determining whether the orientation of the secondary device has changed within a threshold range within a timeout period.

FIG. 8 is a flowchart describing an alternative embodiment of a method for controlling an augmented reality environment using a secondary device.

FIG. 9 is a block diagram of one embodiment of a mobile device.

### DETAILED DESCRIPTION

Technology is described for providing high precision control of an augmented reality environment associated with a head-mounted display device (HMD). In some embodiments, a virtual pointer may be displayed to an end user of the HMD and controlled by the end user using motion and/or orientation information associated with a secondary device (e.g., a mobile phone or other device with the ability to provide motion and/or orientation information to the HMD). Using the virtual pointer, the end user may select and manipulate virtual objects within the augmented reality environment, select real-world objects within the augmented reality environment, and/or control a graphical user interface of the HMD (e.g., the end user may select applications, drag and drop virtual objects, or zoom into portions of the augmented reality environment). If the virtual pointer points to (or overlays) a virtual or real-world object that is selectable, then the HMD may provide feedback to the end user that the object is selectable (e.g., a vibration, a sound, or a visual indicator may be used to alert the end user that additional information associated with the selectable object is available). In some cases, the initial position of the virtual pointer within the augmented reality environment may be determined based on a particular direction in which the end user is gazing and/or a particular object at which the end user is currently focusing on or has recently focused on.

One issue with controlling an augmented reality environment using an HMD is that, unlike other computing devices (e.g., a tablet computer that includes a touchscreen interface), the HMD itself does not provide an interface that allows for the manipulation of objects using hand and/or finger gestures. Moreover, the ability to select objects (e.g., a small object within a field of view of the HMD) may be more precisely controlled by the end user using hand and/or finger movements than adjusting their head orientation, which may also lead to fatigue of the end user's neck. Thus, there is a need for facilitating control of an augmented reality environment associated with an HMD using a secondary device that may be manipulated by an end user of the HMD using arm, hand, and/or finger movements.

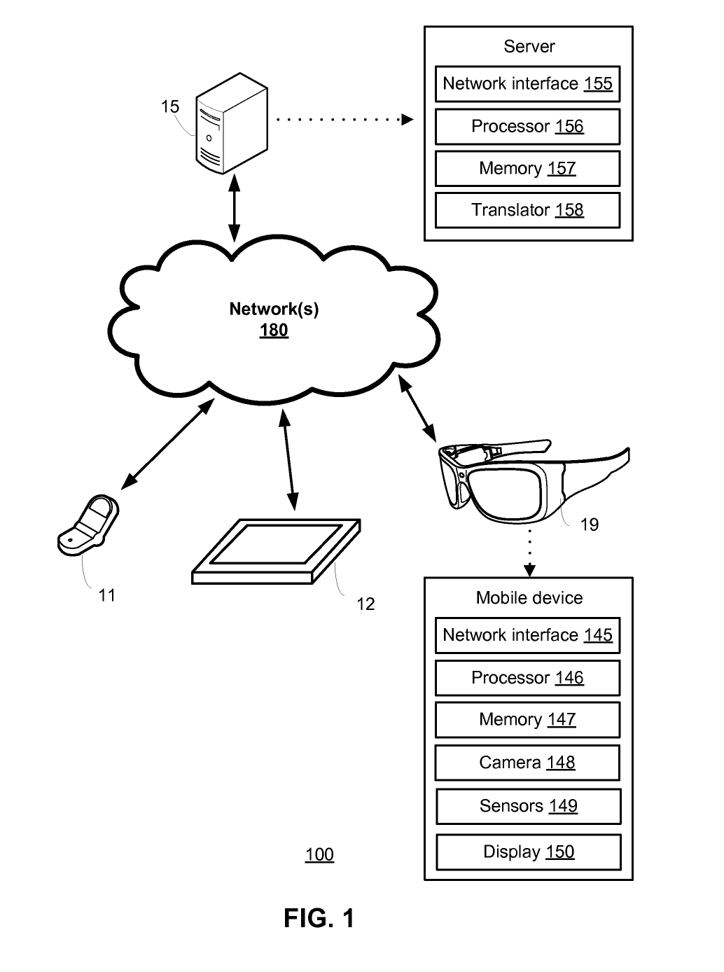

FIG. 1 is a block diagram of one embodiment of a networked computing environment 100 in which the disclosed technology may be practiced. Networked computing environment 100 includes a plurality of computing devices interconnected through one or more networks 180. The one or more networks 180 allow a particular computing device to connect to and communicate with another computing device. The depicted computing devices include mobile device 11, mobile device 12, mobile device 19, and server 15. In some embodiments, the plurality of computing devices may include other computing devices not shown. In some embodiments, the plurality of computing devices may include more than or less than the number of computing devices shown in FIG. 1. The one or more networks 180 may include a secure network such as an enterprise private network, an unsecure network such as a wireless open network, a local area network (LAN), a wide area network (WAN), and the Internet. Each network of the one or more networks 180 may include hubs, bridges, routers, switches, and wired transmission media such as a wired network or direct-wired connection.

Server 15, which may comprise a supplemental information server or an application server, may allow a client to download information (e.g., text, audio, image, and video files) from the server or to perform a search query related to particular information stored on the server. In general, a “server” may include a hardware device that acts as the host in a client-server relationship or a software process that shares a resource with or performs work for one or more clients. Communication between computing devices in a client-server relationship may be initiated by a client sending a request to the server asking for access to a particular resource or for particular work to be performed. The server may subsequently perform the actions requested and send a response back to the client.

One embodiment of server 15 includes a network interface 155, processor 156, memory 157, and translator 158, all in communication with each other. Network interface 155 allows server 15 to connect to one or more networks 180. Network interface 155 may include a wireless network interface, a modem, and/or a wired network interface. Processor 156 allows server 15 to execute computer readable instructions stored in memory 157 in order to perform processes discussed herein. Translator 158 may include mapping logic for translating a first file of a first file format into a corresponding second file of a second file format (i.e., the second file may be a translated version of the first file). Translator 158 may be configured using file mapping instructions that provide instructions for mapping files of a first file format (or portions thereof) into corresponding files of a second file format.

One embodiment of mobile device 19 includes a network interface 145, processor 146, memory 147, camera 148, sensors 149, and display 150, all in communication with each other. Network interface 145 allows mobile device 19 to connect to one or more networks 180. Network interface 145 may include a wireless network interface, a modem, and/or a wired network interface. Processor 146 allows mobile device 19 to execute computer readable instructions stored in memory 147 in order to perform processes discussed herein. Camera 148 may capture color images and/or depth images. Sensors 149 may generate motion and/or orientation information associated with mobile device 19. In some cases, sensors 149 may comprise an inertial measurement unit (IMU). Display 150 may display digital images and/or videos. Display 150 may comprise a see-through display.

In some embodiments, various components of mobile device 19 including the network interface 145, processor 146, memory 147, camera 148, and sensors 149 may be integrated on a single chip substrate. In one example, the network interface 145, processor 146, memory 147, camera 148, and sensors 149 may be integrated as a system on a chip (SOC). In other embodiments, the network interface 145, processor 146, memory 147, camera 148, and sensors 149 may be integrated within a single package.

In some embodiments, mobile device 19 may provide a natural user interface (NUI) by employing camera 148, sensors 149, and gesture recognition software running on processor 146. With a natural user interface, a person's body parts and movements may be detected, interpreted, and used to control various aspects of a computing application. In one example, a computing device utilizing a natural user interface may infer the intent of a person interacting with the computing device (e.g., that the end user has performed a particular gesture in order to control the computing device).

Networked computing environment 100 may provide a cloud computing environment for one or more computing devices. Cloud computing refers to Internet-based computing, wherein shared resources, software, and/or information are provided to one or more computing devices on-demand via the Internet (or other global network). The term “cloud” is used as a metaphor for the Internet, based on the cloud drawings used in computer networking diagrams to depict the Internet as an abstraction of the underlying infrastructure it represents.

In one example, mobile device 19 comprises a head-mounted display device (HMD) that provides an augmented reality environment or a mixed reality environment to an end user of the HMD. The HMD may comprise a video see-through and/or an optical see-through system. An optical see-through HMD worn by an end user may allow actual direct viewing of a real-world environment (e.g., via transparent lenses) and may, at the same time, project images of a virtual object into the visual field of the end user thereby augmenting the real-world environment perceived by the end user with the virtual object.

Utilizing an HMD, an end user may move around a real-world environment (e.g., a living room) wearing the HMD and perceive views of the real-world overlaid with images of virtual objects. The virtual objects may appear to maintain coherent spatial relationship with the real-world environment (i.e., as the end user turns their head or moves within the real-world environment, the images displayed to the end user will change such that the virtual objects appear to exist within the real-world environment as perceived by the end user). The virtual objects may also appear fixed with respect to the end user's point of view (e.g., a virtual menu that always appears in the top right corner of the end user's point of view regardless of how the end user turns their head or moves within the real-world environment). In one embodiment, environmental mapping of the real-world environment may be performed by server 15 (i.e., on the server side) while camera localization may be performed on mobile device 19 (i.e., on the client side). The virtual objects may include a text description associated with a real-world object.

In some embodiments, a mobile device, such as mobile device 19, may be in communication with a server in the cloud, such as server 15, and may provide to the server location information (e.g., the location of the mobile device via GPS coordinates) and/or image information (e.g., information regarding objects detected within a field of view of the mobile device) associated with the mobile device. In response, the server may transmit to the mobile device one or more virtual objects based upon the location information and/or image information provided to the server. In one embodiment, the mobile device 19 may specify a particular file format for receiving the one or more virtual objects and server 15 may transmit to the mobile device 19 the one or more virtual objects embodied within a file of the particular file format.

In some embodiments, a virtual pointer may be displayed to an end user of mobile device 19 and controlled by the end user using motion and/or orientation information associated with a secondary device (e.g., a mobile phone or other device with the ability to provide motion and/or orientation information to the HMD). Using the virtual pointer, the end user may select and manipulate virtual objects within the augmented reality environment, select real-world objects within the augmented reality environment, and/or control a graphical user interface of the HMD (e.g., the end user may select applications, drag and drop virtual objects, or zoom into portions of the augmented reality environment). If the virtual pointer points to (or overlays) a virtual or real-world object that is selectable, then the HMD may provide feedback to the end user that the object is selectable (e.g., a vibration, a sound, or a visual indicator may be used to alert the end user that additional information associated with the selectable object is available). In some cases, the initial position of the virtual pointer within the augmented reality environment may be determined based on a particular direction in which the end user is gazing and/or a particular object at which the end user is currently focusing on or has recently focused on.

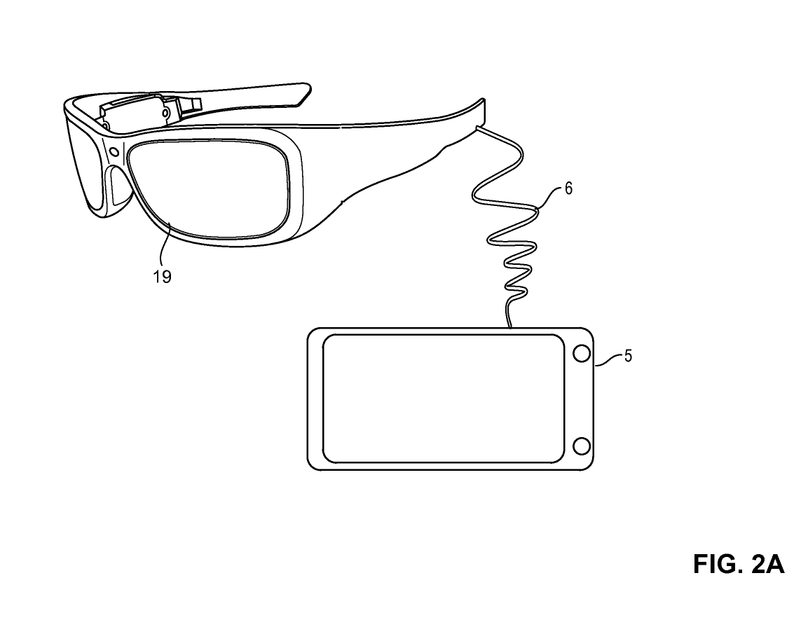

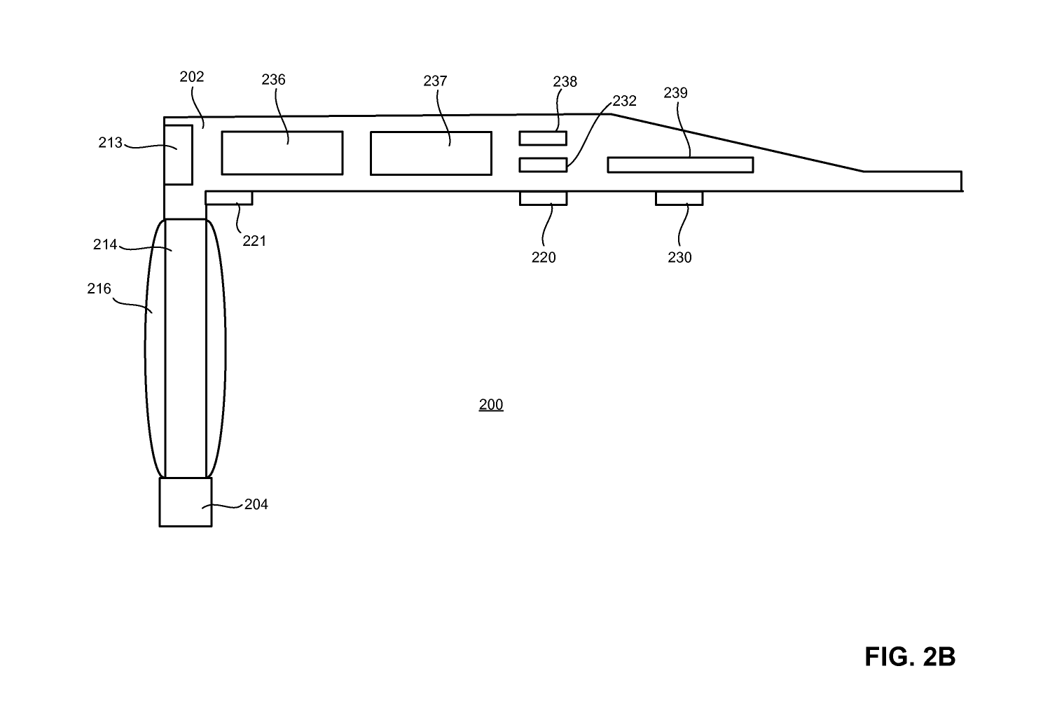

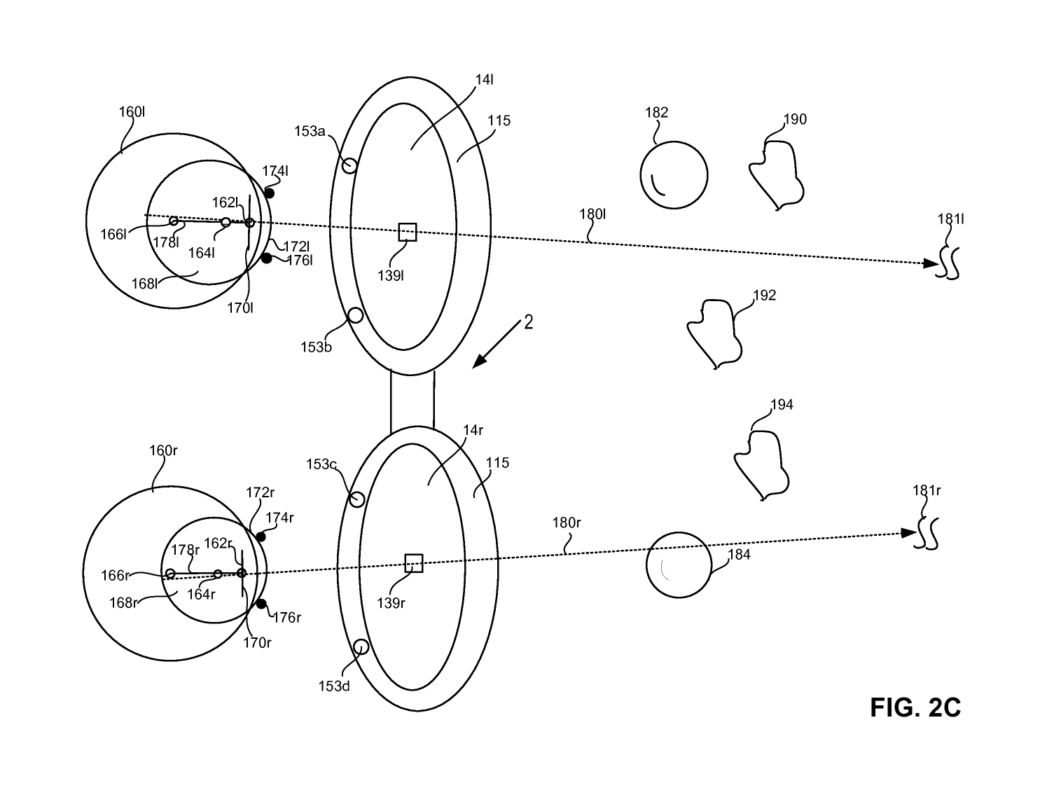

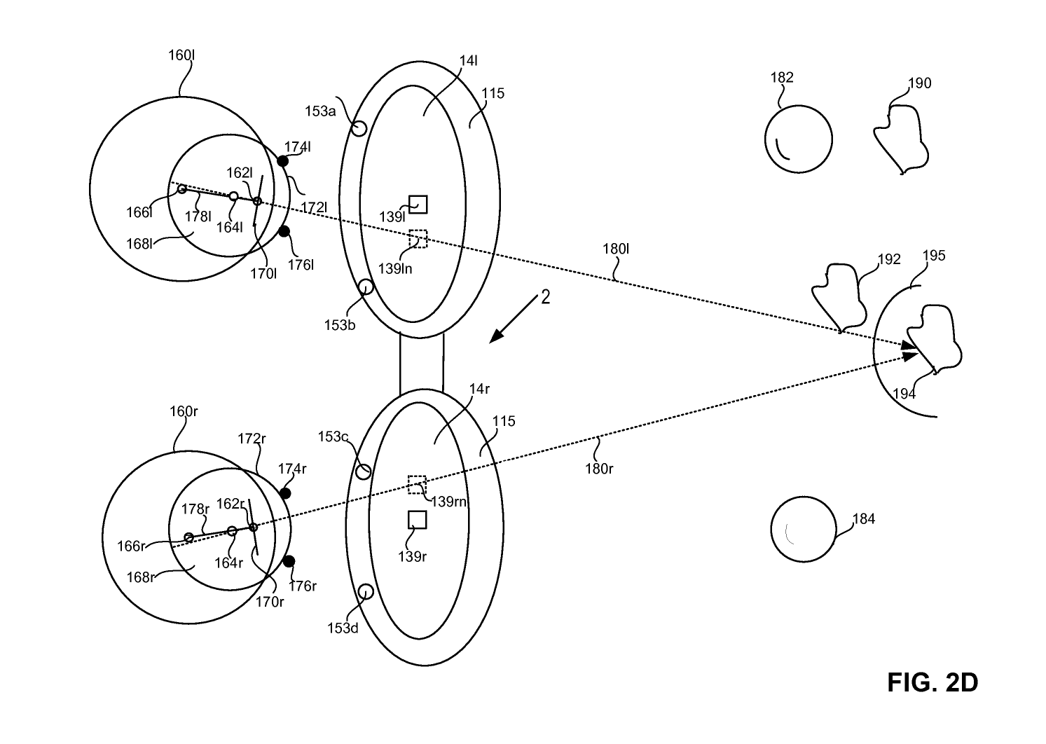

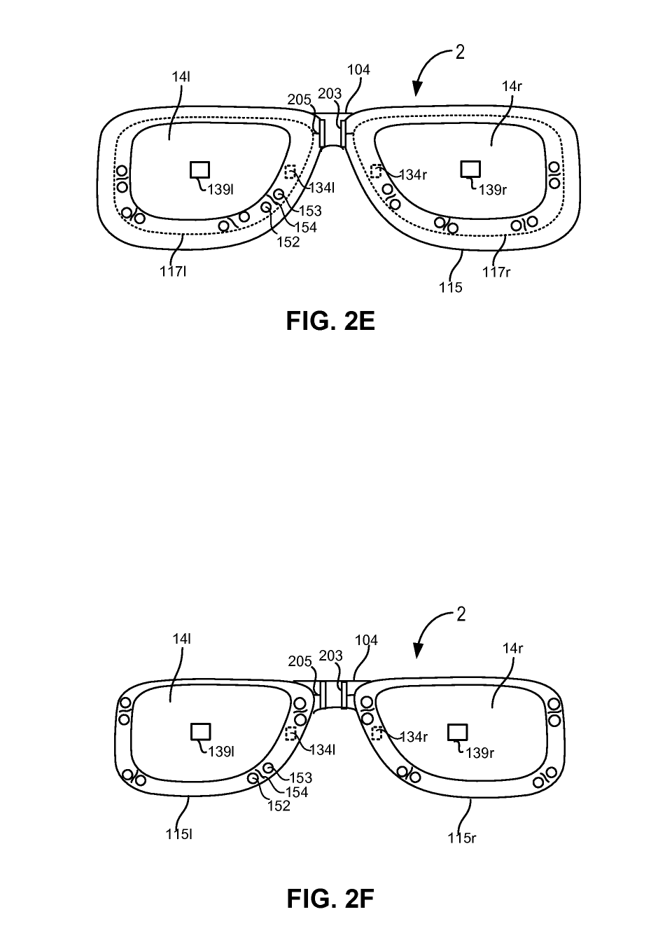

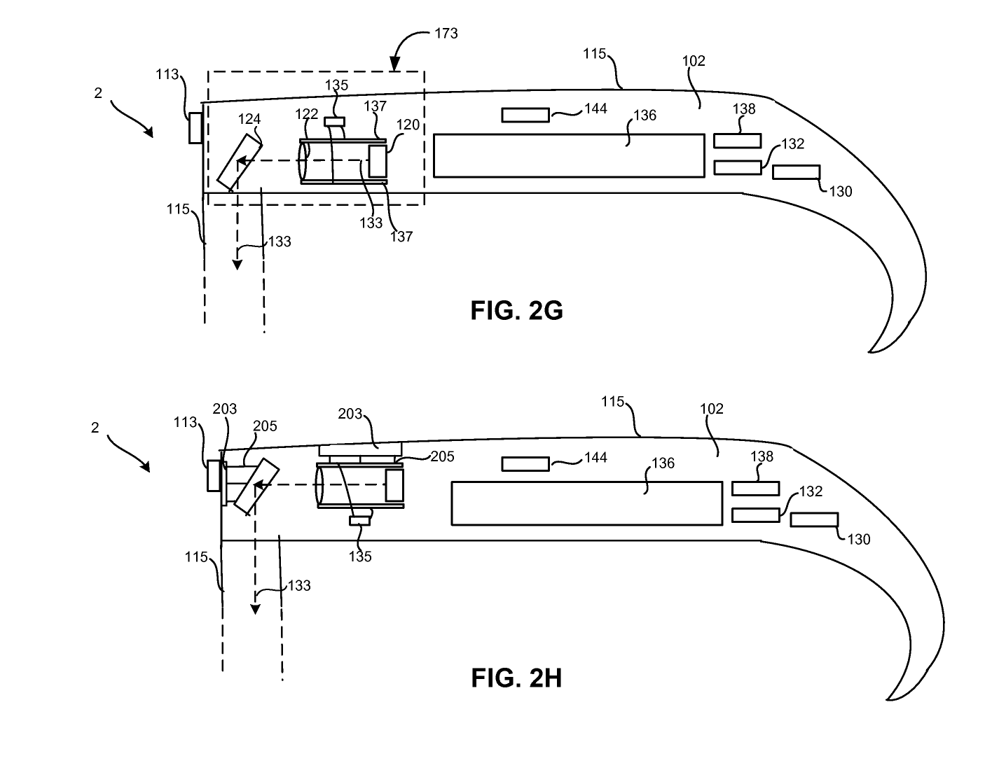

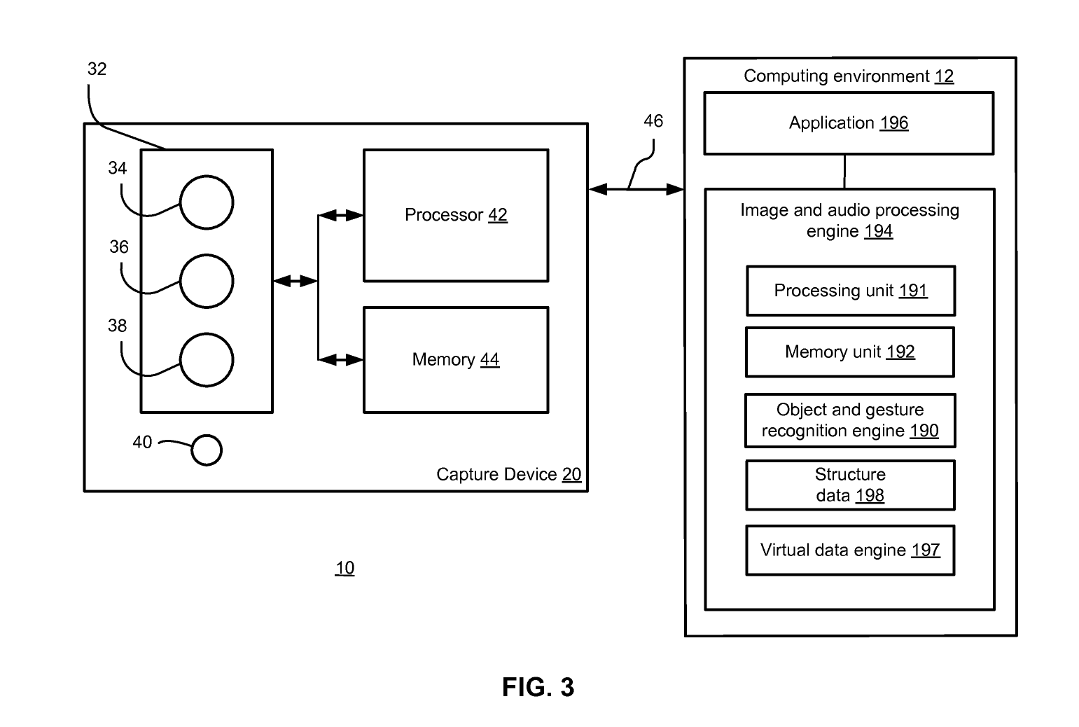

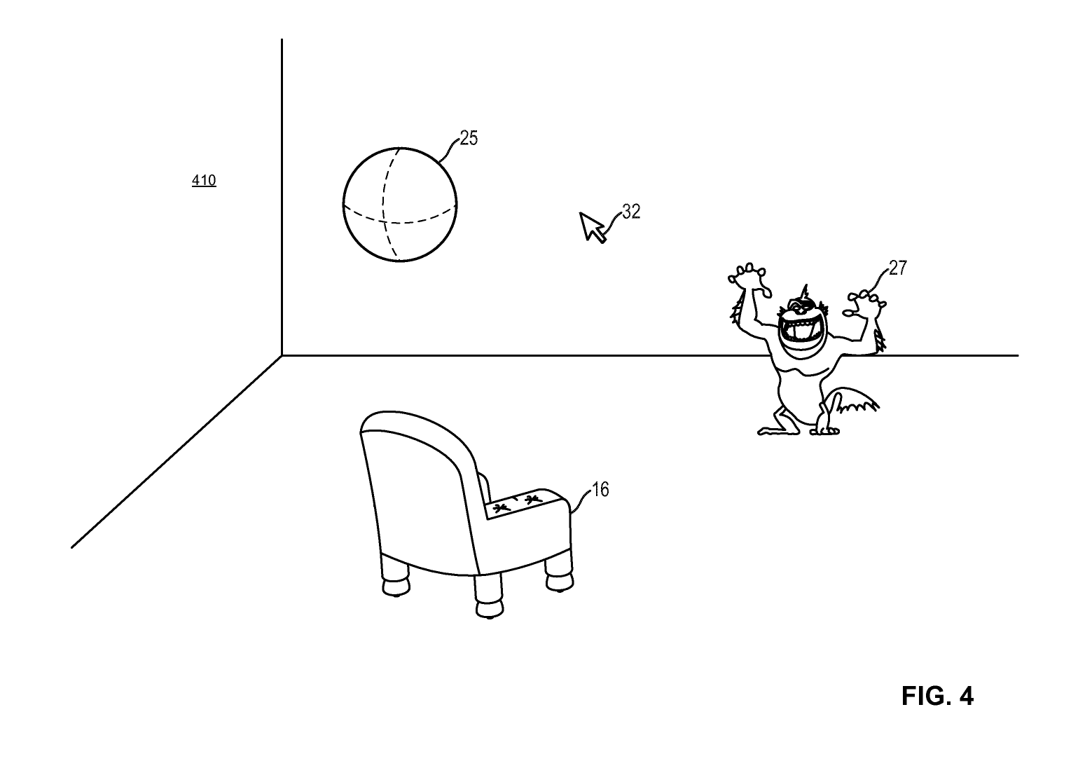

FIG. 2A depicts one embodiment of a mobile device 19 in communication with a second mobile device 5. Mobile device 19 may comprise a see-through HMD. As depicted, mobile device 19 communicates with mobile device 5 via a wired connection 6. However, the mobile device 19 may also communicate with mobile device 5 via a wireless connection. Mobile device 5 may be used by mobile device 19 in order to offload compute intensive processing tasks (e.g., the rendering of virtual objects) and to store virtual object information and other data that may be used to provide an augmented reality environment on mobile device 19. Mobile device 5 may also provide motion and/or orientation information associated with mobile device 5 to mobile device 19. In one example, the motion information may include a velocity or acceleration associated with the mobile device 5 and the orientation information may include Euler angles, which provide rotational information around a particular coordinate system or frame of reference. In some cases, mobile device 5 may include a motion and orientation sensor, such as an inertial measurement unit (IMU), in order to acquire motion and/or orientation information associated with mobile device 5.

FIG. 2B depicts one embodiment of a portion of an HMD, such as mobile device 19 in FIG. 1. Only the right side of an HMD 200 is depicted. HMD 200 includes right temple 202, nose bridge 204, eye glass 216, and eye glass frame 214. Right temple 202 includes a capture device 213 (e.g., a front facing camera and/or microphone) in communication with processing unit 236. The capture device 213 may include one or more cameras for recording digital images and/or videos and may transmit the visual recordings to processing unit 236. The one or more cameras may capture color information, IR information, and/or depth information. The capture device 213 may also include one or more microphones for recording sounds and may transmit the audio recordings to processing unit 236.

Right temple 202 also includes biometric sensor 220, eye tracking system 221, ear phones 230, motion and orientation sensor 238, GPS receiver 232, power supply 239, and wireless interface 237, all in communication with processing unit 236. Biometric sensor 220 may include one or more electrodes for determining a pulse or heart rate associated with an end user of HMD 200 and a temperature sensor for determining a body temperature associated with the end user of HMD 200. In one embodiment, biometric sensor 220 includes a pulse rate measuring sensor which presses against the temple of the end user. Motion and orientation sensor 238 may include a three axis magnetometer, a three axis gyro, and/or a three axis accelerometer. In one embodiment, the motion and orientation sensor 238 may comprise an inertial measurement unit (IMU). The GPS receiver may determine a GPS location associated with HMD 200. Processing unit 236 may include one or more processors and a memory for storing computer readable instructions to be executed on the one or more processors. The memory may also store other types of data to be executed on the one or more processors.

In one embodiment, the eye tracking system 221 may include an inward facing camera. In another embodiment, the eye tracking system 221 may comprise an eye tracking illumination source and an associated eye tracking IR sensor. In one embodiment, the eye tracking illumination source may include one or more infrared (IR) emitters such as an infrared light emitting diode (LED) or a laser (e.g. VCSEL) emitting about a predetermined IR wavelength or a range of wavelengths. In some embodiments, the eye tracking sensor may include an IR camera or an IR position sensitive detector (PSD) for tracking glint positions. More information about eye tracking systems can be found in U.S. Pat. No. 7,401,920, entitled “Head Mounted Eye Tracking and Display System”, issued Jul. 22, 2008, and U.S. patent application Ser. No. 13/245,700, entitled “Integrated Eye Tracking and Display System,” filed Sep. 26, 2011, both of which are herein incorporated by reference.

In one embodiment, eye glass 216 may comprise a see-through display, whereby images generated by processing unit 236 may be projected and/or displayed on the see-through display. The capture device 213 may be calibrated such that a field of view captured by the capture device 213 corresponds with the field of view as seen by an end user of HMD 200. The ear phones 230 may be used to output sounds associated with the projected images of virtual objects. In some embodiments, HMD 200 may include two or more front facing cameras (e.g., one on each temple) in order to obtain depth from stereo information associated with the field of view captured by the front facing cameras. The two or more front facing cameras may also comprise 3D, IR, and/or RGB cameras. Depth information may also be acquired from a single camera utilizing depth from motion techniques. For example, two images may be acquired from the single camera associated with two different points in space at different points in time. Parallax calculations may then be performed given position information regarding the two different points in space.

In some embodiments, HMD 200 may perform gaze detection for each eye of an end user's eyes using gaze detection elements and a three-dimensional coordinate system in relation to one or more human eye elements such as a cornea center, a center of eyeball rotation, or a pupil center. Gaze detection may be used to identify where the end user is focusing within a field of view. Examples of gaze detection elements may include glint generating illuminators and sensors for capturing data representing the generated glints. In some cases, the center of the cornea can be determined based on two glints using planar geometry. The center of the cornea links the pupil center and the center of rotation of the eyeball, which may be treated as a fixed location for determining an optical axis of the end user's eye at a certain gaze or viewing angle.

FIG. 2C depicts one embodiment of a portion of an HMD 2 in which gaze vectors extending to a point of gaze are used for aligning a far inter-pupillary distance (IPD). HMD 2 is one example of a mobile device, such as mobile device 19 in FIG. 1. As depicted, gaze vectors 180l and 180r intersect at a point of gaze that is far away from the end user (i.e., the gaze vectors 180l and 180r do not intersect as the end user is looking at an object far away). A model of the eyeball for eyeballs 160l and 160r is illustrated for each eye based on the Gullstrand schematic eye model. Each eyeball is modeled as a sphere with a center of rotation 166 and includes a cornea 168 modeled as a sphere having a center 164. The cornea 168 rotates with the eyeball, and the center of rotation 166 of the eyeball may be treated as a fixed point. The cornea 168 covers an iris 170 with a pupil 162 at its center. On the surface 172 of each cornea are glints 174 and 176.

As depicted in FIG. 2C, a sensor detection area 139 (i.e., 139l and 139r, respectively) is aligned with the optical axis of each display optical system 14 within an eyeglass frame 115. In one example, the sensor associated with the detection area may include one or more cameras capable of capturing image data representing glints 174l and 176l generated respectively by illuminators 153a and 153b on the left side of the frame 115 and data representing glints 174r and 176r generated respectively by illuminators 153c and 153d on the right side of the frame 115. Through the display optical systems 14l and 14r in the eyeglass frame 115, the end user's field of view includes both real objects 190, 192, and 194 and virtual objects 182 and 184.

The axis 178 formed from the center of rotation 166 through the cornea center 164 to the pupil 162 comprises the optical axis of the eye. A gaze vector 180 may also be referred to as the line of sight or visual axis which extends from the fovea through the center of the pupil 162. In some embodiments, the optical axis is determined and a small correction is determined through user calibration to obtain the visual axis which is selected as the gaze vector. For each end user, a virtual object may be displayed by the display device at each of a number of predetermined positions at different horizontal and vertical positions. An optical axis may be computed for each eye during display of the object at each position, and a ray modeled as extending from the position into the user's eye. A gaze offset angle with horizontal and vertical components may be determined based on how the optical axis must be moved to align with the modeled ray. From the different positions, an average gaze offset angle with horizontal or vertical components can be selected as the small correction to be applied to each computed optical axis. In some embodiments, only a horizontal component is used for the gaze offset angle correction.

As depicted in FIG. 2C, the gaze vectors 180l and 180r are not perfectly parallel as the vectors become closer together as they extend from the eyeball into the field of view at a point of gaze. At each display optical system 14, the gaze vector 180 appears to intersect the optical axis upon which the sensor detection area 139 is centered. In this configuration, the optical axes are aligned with the inter-pupillary distance (IPD). When an end user is looking straight ahead, the IPD measured is also referred to as the far IPD.

FIG. 2D depicts one embodiment of a portion of an HMD 2 in which gaze vectors extending to a point of gaze are used for aligning a near inter-pupillary distance (IPD). HMD 2 is one example of a mobile device, such as mobile device 19 in FIG. 1. As depicted, the cornea 168l of the left eye is rotated to the right or towards the end user's nose, and the cornea 168r of the right eye is rotated to the left or towards the end user's nose. Both pupils are gazing at a real object 194 within a particular distance of the end user. Gaze vectors 180l and 180r from each eye enter the Panum's fusional region 195 in which real object 194 is located. The Panum's fusional region is the area of single vision in a binocular viewing system like that of human vision. The intersection of the gaze vectors 180l and 180r indicates that the end user is looking at real object 194. At such a distance, as the eyeballs rotate inward, the distance between their pupils decreases to a near IPD. The near IPD is typically about 4 mm less than the far IPD. A near IPD distance criteria (e.g., a point of gaze at less than four feet from the end user) may be used to switch or adjust the IPD alignment of the display optical systems 14 to that of the near IPD. For the near IPD, each display optical system 14 may be moved toward the end user's nose so the optical axis, and detection area 139, moves toward the nose a few millimeters as represented by detection areas 139ln and 139rn.

More information about determining the IPD for an end user of an HMD and adjusting the display optical systems accordingly can be found in U.S. patent application Ser. No. 13/250,878, entitled “Personal Audio/Visual System,” filed Sep. 30, 2011, which is herein incorporated by reference in its entirety.

FIG. 2E depicts one embodiment of a portion of an HMD 2 with movable display optical systems including gaze detection elements. What appears as a lens for each eye represents a display optical system 14 for each eye (i.e., 14l and 14r). A display optical system includes a see-through lens and optical elements (e.g. mirrors, filters) for seamlessly fusing virtual content with the actual direct real world view seen through the lenses of the HMD. A display optical system 14 has an optical axis which is generally in the center of the see-through lens in which light is generally collimated to provide a distortionless view. For example, when an eye care professional fits an ordinary pair of eyeglasses to an end user's face, the glasses are usually fit such that they sit on the end user's nose at a position where each pupil is aligned with the center or optical axis of the respective lens resulting in generally collimated light reaching the end user's eye for a clear or distortionless view.

As depicted in FIG. 2E, a detection area 139r, 139l of at least one sensor is aligned with the optical axis of its respective display optical system 14r, 14l so that the center of the detection area 139r, 139l is capturing light along the optical axis. If the display optical system 14 is aligned with the end user's pupil, then each detection area 139 of the respective sensor 134 is aligned with the end user's pupil. Reflected light of the detection area 139 is transferred via one or more optical elements to the actual image sensor 134 of the camera, which in the embodiment depicted is illustrated by the dashed line as being inside the frame 115.

In one embodiment, the at least one sensor 134 may be a visible light camera (e.g., an RGB camera). In one example, an optical element or light directing element comprises a visible light reflecting mirror which is partially transmissive and partially reflective. The visible light camera provides image data of the pupil of the end user's eye, while IR photodetectors 152 capture glints which are reflections in the IR portion of the spectrum. If a visible light camera is used, reflections of virtual images may appear in the eye data captured by the camera. An image filtering technique may be used to remove the virtual image reflections if desired. An IR camera is not sensitive to the virtual image reflections on the eye.

In another embodiment, the at least one sensor 134 (i.e., 134l and 134r) is an IR camera or a position sensitive detector (PSD) to which the IR radiation may be directed. The IR radiation reflected from the eye may be from incident radiation of the illuminators 153, other IR illuminators (not shown), or from ambient IR radiation reflected off the eye. In some cases, sensor 134 may be a combination of an RGB and an IR camera, and the light directing elements may include a visible light reflecting or diverting element and an IR radiation reflecting or diverting element. In some cases, the sensor 134 may be embedded within a lens of the system 14. Additionally, an image filtering technique may be applied to blend the camera into a user field of view to lessen any distraction to the user.

As depicted in FIG. 2E, there are four sets of an illuminator 153 paired with a photodetector 152 and separated by a barrier 154 to avoid interference between the incident light generated by the illuminator 153 and the reflected light received at the photodetector 152. To avoid unnecessary clutter in the drawings, drawing numerals are shown with respect to a representative pair. Each illuminator may be an infra-red (IR) illuminator which generates a narrow beam of light at about a predetermined wavelength. Each of the photodetectors may be selected to capture light at about the predetermined wavelength. Infra-red may also include near-infrared. As there can be wavelength drift of an illuminator or photodetector or a small range about a wavelength may be acceptable, the illuminator and photodetector may have a tolerance range about a wavelength for generation and detection. In some embodiments where the sensor is an IR camera or IR position sensitive detector (PSD), the photodetectors may include additional data capture devices and may also be used to monitor the operation of the illuminators, e.g. wavelength drift, beam width changes, etc. The photodetectors may also provide glint data with a visible light camera as the sensor 134.

As depicted in FIG. 2E, each display optical system 14 and its arrangement of gaze detection elements facing each eye (e.g., such as camera 134 and its detection area 139, the illuminators 153, and photodetectors 152) are located on a movable inner frame portion 117l, 117r. In this example, a display adjustment mechanism comprises one or more motors 203 having a shaft 205 which attaches to the inner frame portion 117 which slides from left to right or vice versa within the frame 115 under the guidance and power of shafts 205 driven by motors 203. In some embodiments, one motor 203 may drive both inner frames.

FIG. 2F depicts an alternative embodiment of a portion of an HMD 2 with movable display optical systems including gaze detection elements. As depicted, each display optical system 14 is enclosed in a separate frame portion 115l, 115r. Each of the frame portions may be moved separately by the motors 203. More information about HMDs with movable display optical systems can be found in U.S. patent application Ser. No. 13/250,878, entitled “Personal Audio/Visual System,” filed Sep. 30, 2011, which is herein incorporated by reference in its entirety.

FIG. 2G depicts one embodiment of a side view of a portion of an HMD 2 including an eyeglass temple 102 of the frame 115. At the front of frame 115 is a front facing video camera 113 that can capture video and still images. In some embodiments, front facing camera 113 may include a depth camera as well as a visible light or RGB camera. In one example, the depth camera may include an IR illuminator transmitter and a hot reflecting surface like a hot mirror in front of the visible image sensor which lets the visible light pass and directs reflected IR radiation within a wavelength range or about a predetermined wavelength transmitted by the illuminator to a CCD or other type of depth sensor. Other types of visible light cameras (e.g., an RGB camera or image sensor) and depth cameras can be used. More information about depth cameras can be found in U.S. patent application Ser. No. 12/813,675, filed on Jun. 11, 2010, incorporated herein by reference in its entirety. The data from the cameras may be sent to control circuitry 136 for processing in order to identify objects through image segmentation and/or edge detection techniques.

Inside temple 102, or mounted to temple 102, are ear phones 130, inertial sensors 132, GPS transceiver 144, and temperature sensor 138. In one embodiment, inertial sensors 132 include a three axis magnetometer, three axis gyro, and three axis accelerometer. The inertial sensors are for sensing position, orientation, and sudden accelerations of HMD 2. From these movements, head position may also be determined.

In some cases, HMD 2 may include an image generation unit which can create one or more images including one or more virtual objects. In some embodiments, a microdisplay may be used as the image generation unit. As depicted, microdisplay assembly 173 comprises light processing elements and a variable focus adjuster 135. An example of a light processing element is a microdisplay unit 120. Other examples include one or more optical elements such as one or more lenses of a lens system 122 and one or more reflecting elements such as surfaces 124. Lens system 122 may comprise a single lens or a plurality of lenses.

Mounted to or inside temple 102, the microdisplay unit 120 includes an image source and generates an image of a virtual object. The microdisplay unit 120 is optically aligned with the lens system 122 and the reflecting surface 124. The optical alignment may be along an optical axis 133 or an optical path 133 including one or more optical axes. The microdisplay unit 120 projects the image of the virtual object through lens system 122, which may direct the image light onto reflecting element 124. The variable focus adjuster 135 changes the displacement between one or more light processing elements in the optical path of the microdisplay assembly or an optical power of an element in the microdisplay assembly. The optical power of a lens is defined as the reciprocal of its focal length (i.e., 1/focal length) so a change in one effects the other. The change in focal length results in a change in the region of the field of view which is in focus for an image generated by the microdisplay assembly 173.

In one example of the microdisplay assembly 173 making displacement changes, the displacement changes are guided within an armature 137 supporting at least one light processing element such as the lens system 122 and the microdisplay 120. The armature 137 helps stabilize the alignment along the optical path 133 during physical movement of the elements to achieve a selected displacement or optical power. In some examples, the adjuster 135 may move one or more optical elements such as a lens in lens system 122 within the armature 137. In other examples, the armature may have grooves or space in the area around a light processing element so it slides over the element, for example, microdisplay 120, without moving the light processing element. Another element in the armature such as the lens system 122 is attached so that the system 122 or a lens within slides or moves with the moving armature 137. The displacement range is typically on the order of a few millimeters (mm). In one example, the range is 1-2 mm. In other examples, the armature 137 may provide support to the lens system 122 for focal adjustment techniques involving adjustment of other physical parameters than displacement. An example of such a parameter is polarization.

More information about adjusting a focal distance of a microdisplay assembly can be found in U.S. patent Ser. No. 12/941,825 entitled “Automatic Variable Virtual Focus for Augmented Reality Displays,” filed Nov. 8, 2010, which is herein incorporated by reference in its entirety.

In one embodiment, the adjuster 135 may be an actuator such as a piezoelectric motor. Other technologies for the actuator may also be used and some examples of such technologies are a voice coil formed of a coil and a permanent magnet, a magnetostriction element, and an electrostriction element.

Several different image generation technologies may be used to implement microdisplay 120. In one example, microdisplay 120 can be implemented using a transmissive projection technology where the light source is modulated by optically active material and backlit with white light. These technologies are usually implemented using LCD type displays with powerful backlights and high optical energy densities. Microdisplay 120 can also be implemented using a reflective technology for which external light is reflected and modulated by an optically active material. The illumination may be forward lit by either a white source or RGB source, depending on the technology. Digital light processing (DLP), liquid crystal on silicon (LCOS) and Mirasol® display technology from Qualcomm, Inc. are all examples of reflective technologies which are efficient as most energy is reflected away from the modulated structure and may be used in the system described herein. Additionally, microdisplay 120 can be implemented using an emissive technology where light is generated by the display. For example, a PicoP™ engine from Microvision, Inc. emits a laser signal with a micro mirror steering either onto a tiny screen that acts as a transmissive element or beamed directly into the eye (e.g., laser).

FIG. 2H depicts one embodiment of a side view of a portion of an HMD 2 which provides support for a three dimensional adjustment of a microdisplay assembly. Some of the numerals illustrated in the FIG. 2G above have been removed to avoid clutter in the drawing. In some embodiments where the display optical system 14 is moved in any of three dimensions, the optical elements represented by reflecting surface 124 and the other elements of the microdisplay assembly 173 may also be moved for maintaining the optical path 133 of the light of a virtual image to the display optical system. An XYZ transport mechanism in this example made up of one or more motors represented by motor block 203 and shafts 205 under control of control circuitry 136 control movement of the elements of the microdisplay assembly 173. An example of motors which may be used are piezoelectric motors. In the illustrated example, one motor is attached to the armature 137 and moves the variable focus adjuster 135 as well, and another representative motor 203 controls the movement of the reflecting element 124.

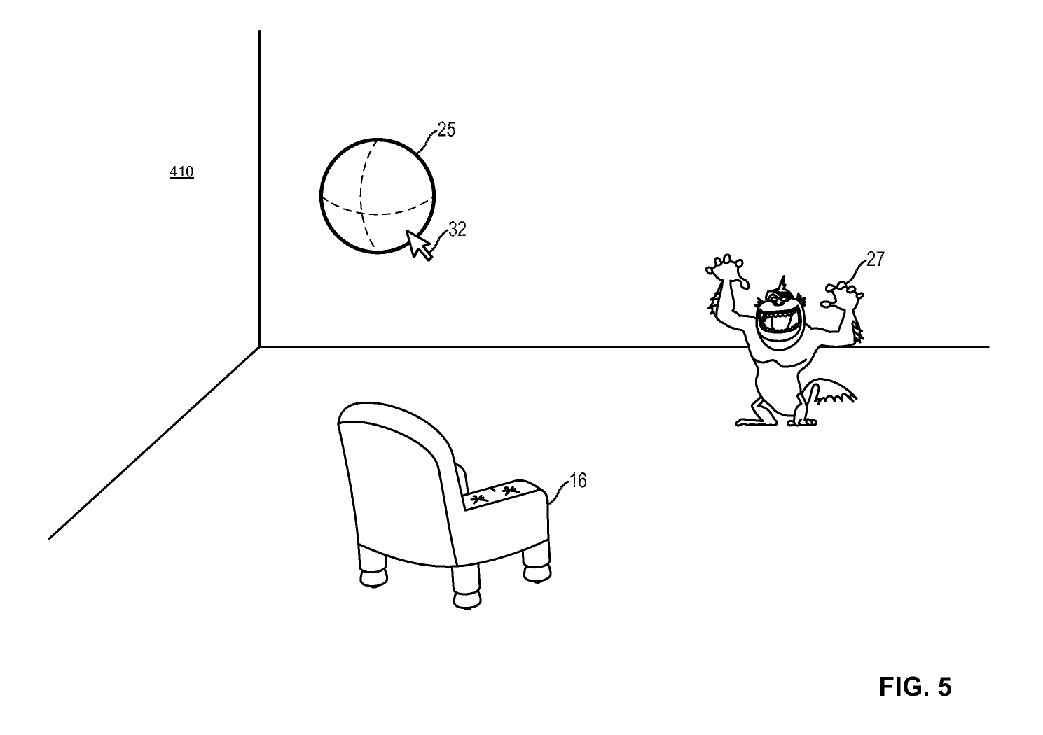

FIG. 3 depicts one embodiment of a computing system 10 including a capture device 20 and computing environment 12. In some embodiments, capture device 20 and computing environment 12 may be integrated within a single mobile computing device. The single integrated mobile computing device may comprise a mobile device, such as mobile device 19 in FIG. 1. In one example, the capture device 20 and computing environment 12 may be integrated within an HMD. In other embodiments, capture device 20 may be integrated with a first mobile device, such as mobile device 19 in FIG. 2A, and computing environment 12 may be integrated with a second mobile device in communication with the first mobile device, such as mobile device 5 in FIG. 2A.

In one embodiment, the capture device 20 may include one or more image sensors for capturing images and videos. An image sensor may comprise a CCD image sensor or a CMOS image sensor. In some embodiments, capture device 20 may include an IR CMOS image sensor. The capture device 20 may also include a depth sensor (or depth sensing camera) configured to capture video with depth information including a depth image that may include depth values via any suitable technique including, for example, time-of-flight, structured light, stereo image, or the like.

The capture device 20 may include an image camera component 32. In one embodiment, the image camera component 32 may include a depth camera that may capture a depth image of a scene. The depth image may include a two-dimensional (2D) pixel area of the captured scene where each pixel in the 2D pixel area may represent a depth value such as a distance in, for example, centimeters, millimeters, or the like of an object in the captured scene from the image camera component 32.

The image camera component 32 may include an IR light component 34, a three-dimensional (3D) camera 36, and an RGB camera 38 that may be used to capture the depth image of a capture area. For example, in time-of-flight analysis, the IR light component 34 of the capture device 20 may emit an infrared light onto the capture area and may then use sensors to detect the backscattered light from the surface of one or more objects in the capture area using, for example, the 3D camera 36 and/or the RGB camera 38. In some embodiments, pulsed infrared light may be used such that the time between an outgoing light pulse and a corresponding incoming light pulse may be measured and used to determine a physical distance from the capture device 20 to a particular location on the one or more objects in the capture area. Additionally, the phase of the outgoing light wave may be compared to the phase of the incoming light wave to determine a phase shift. The phase shift may then be used to determine a physical distance from the capture device to a particular location associated with the one or more objects.

In another example, the capture device 20 may use structured light to capture depth information. In such an analysis, patterned light (i.e., light displayed as a known pattern such as grid pattern or a stripe pattern) may be projected onto the capture area via, for example, the IR light component 34. Upon striking the surface of one or more objects (or targets) in the capture area, the pattern may become deformed in response. Such a deformation of the pattern may be captured by, for example, the 3-D camera 36 and/or the RGB camera 38 and analyzed to determine a physical distance from the capture device to a particular location on the one or more objects. Capture device 20 may include optics for producing collimated light. In some embodiments, a laser projector may be used to create a structured light pattern. The light projector may include a laser, laser diode, and/or LED.

In some embodiments, two or more different cameras may be incorporated into an integrated capture device. For example, a depth camera and a video camera (e.g., an RGB video camera) may be incorporated into a common capture device. In some embodiments, two or more separate capture devices of the same or differing types may be cooperatively used. For example, a depth camera and a separate video camera may be used, two video cameras may be used, two depth cameras may be used, two RGB cameras may be used, or any combination and number of cameras may be used. In one embodiment, the capture device 20 may include two or more physically separated cameras that may view a capture area from different angles to obtain visual stereo data that may be resolved to generate depth information. Depth may also be determined by capturing images using a plurality of detectors that may be monochromatic, infrared, RGB, or any other type of detector and performing a parallax calculation. Other types of depth image sensors can also be used to create a depth image.

As depicted in FIG. 3, capture device 20 may include one or more microphones 40. Each of the one or more microphones 40 may include a transducer or sensor that may receive and convert sound into an electrical signal. The one or more microphones may comprise a microphone array in which the one or more microphones may be arranged in a predetermined layout.

The capture device 20 may include a processor 42 that may be in operative communication with the image camera component 32. The processor 42 may include a standardized processor, a specialized processor, a microprocessor, or the like. The processor 42 may execute instructions that may include instructions for storing filters or profiles, receiving and analyzing images, determining whether a particular situation has occurred, or any other suitable instructions. It is to be understood that at least some image analysis and/or target analysis and tracking operations may be executed by processors contained within one or more capture devices such as capture device 20.

The capture device 20 may include a memory 44 that may store the instructions that may be executed by the processor 42, images or frames of images captured by the 3D camera or RGB camera, filters or profiles, or any other suitable information, images, or the like. In one example, the memory 44 may include random access memory (RAM), read only memory (ROM), cache, Flash memory, a hard disk, or any other suitable storage component. As depicted, the memory 44 may be a separate component in communication with the image capture component 32 and the processor 42. In another embodiment, the memory 44 may be integrated into the processor 42 and/or the image capture component 32. In other embodiments, some or all of the components 32, 34, 36, 38, 40, 42 and 44 of the capture device 20 may be housed in a single housing.

The capture device 20 may be in communication with the computing environment 12 via a communication link 46. The communication link 46 may be a wired connection including, for example, a USB connection, a FireWire connection, an Ethernet cable connection, or the like and/or a wireless connection such as a wireless 802.11b, g, a, or n connection. The computing environment 12 may provide a clock to the capture device 20 that may be used to determine when to capture, for example, a scene via the communication link 46. In one embodiment, the capture device 20 may provide the images captured by, for example, the 3D camera 36 and/or the RGB camera 38 to the computing environment 12 via the communication link 46.

As depicted in FIG. 3, computing environment 12 includes image and audio processing engine 194 in communication with application 196. Application 196 may comprise an operating system application or other computing application such as a gaming application. Image and audio processing engine 194 includes virtual data engine 197, object and gesture recognition engine 190, structure data 198, processing unit 191, and memory unit 192, all in communication with each other. Image and audio processing engine 194 processes video, image, and audio data received from capture device 20. To assist in the detection and/or tracking of objects, image and audio processing engine 194 may utilize structure data 198 and object and gesture recognition engine 190. Virtual data engine 197 processes virtual objects and registers the position and orientation of virtual objects in relation to various maps of a real-world environment stored in memory unit 192.

Processing unit 191 may include one or more processors for executing object, facial, and voice recognition algorithms. In one embodiment, image and audio processing engine 194 may apply object recognition and facial recognition techniques to image or video data. For example, object recognition may be used to detect particular objects (e.g., soccer balls, cars, people, or landmarks) and facial recognition may be used to detect the face of a particular person. Image and audio processing engine 194 may apply audio and voice recognition techniques to audio data. For example, audio recognition may be used to detect a particular sound. The particular faces, voices, sounds, and objects to be detected may be stored in one or more memories contained in memory unit 192. Processing unit 191 may execute computer readable instructions stored in memory unit 192 in order to perform processes discussed herein.

The image and audio processing engine 194 may utilize structural data 198 while performing object recognition. Structure data 198 may include structural information about targets and/or objects to be tracked. For example, a skeletal model of a human may be stored to help recognize body parts. In another example, structure data 198 may include structural information regarding one or more inanimate objects in order to help recognize the one or more inanimate objects.

The image and audio processing engine 194 may also utilize object and gesture recognition engine 190 while performing gesture recognition. In one example, object and gesture recognition engine 190 may include a collection of gesture filters, each comprising information concerning a gesture that may be performed by a skeletal model. The object and gesture recognition engine 190 may compare the data captured by capture device 20 in the form of the skeletal model and movements associated with it to the gesture filters in a gesture library to identify when a user (as represented by the skeletal model) has performed one or more gestures. In one example, image and audio processing engine 194 may use the object and gesture recognition engine 190 to help interpret movements of a skeletal model and to detect the performance of a particular gesture.

In some embodiments, one or more objects being tracked may be augmented with one or more markers such as an IR retroreflective marker to improve object detection and/or tracking. Planar reference images, coded AR markers, QR codes, and/or bar codes may also be used to improve object detection and/or tracking. Upon detection of one or more objects and/or gestures, image and audio processing engine 194 may report to application 196 an identification of each object or gesture detected and a corresponding position and/or orientation if applicable.

More information about detecting and tracking objects can be found in U.S. patent application Ser. No. 12/641,788, “Motion Detection Using Depth Images,” filed on Dec. 18, 2009; and U.S. patent application Ser. No. 12/475,308, “Device for Identifying and Tracking Multiple Humans over Time,” both of which are incorporated herein by reference in their entirety. More information about object and gesture recognition engine 190 can be found in U.S. patent application Ser. No. 12/422,661, “Gesture Recognizer System Architecture,” filed on Apr. 13, 2009, incorporated herein by reference in its entirety. More information about recognizing gestures can be found in U.S. patent application Ser. No. 12/391,150, “Standard Gestures,” filed on Feb. 23, 2009; and U.S. patent application Ser. No. 12/474,655, “Gesture Tool,” filed on May 29, 2009, both of which are incorporated by reference herein in their entirety.

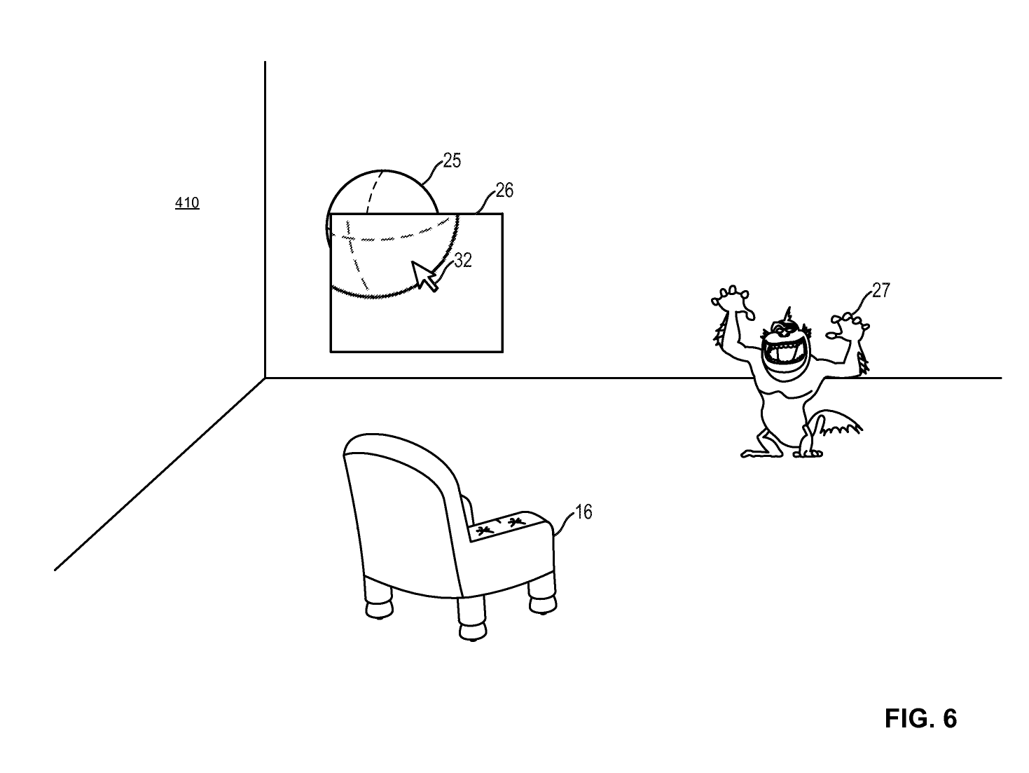

FIGS. 4-6 depict various embodiments of various augmented reality environments in which a virtual pointer may be displayed to an end user of an HMD and controlled by the end user using motion and/or orientation information associated with a secondary device. Using the virtual pointer, the end user may select and manipulate virtual objects within the augmented reality environment, select real-world objects within the augmented reality environment, and/or control a graphical user interface of the HMD (e.g., the end user may select applications, drag and drop virtual objects, or zoom into portions of the augmented reality environment).

FIG. 4 depicts one embodiment of an augmented reality environment 410 as seen by an end user wearing an HMD, such as mobile device 19 in FIG. 1. As depicted, the augmented reality environment 410 has been augmented with a virtual pointer 32, a virtual ball 25, and a virtual monster 27. The augmented reality environment 410 also includes a real-world object comprising a chair 16. Using the virtual pointer 32, the end user may select and manipulate virtual objects, such as virtual ball 25 and virtual monster 27, and select real-world objects such as chair 16. In some cases, the end user may select an object (real or virtual) within the augmented reality environment 410 in order to acquire and display additional information associated with the object. The end user may also move, reposition, and/or drag and drop virtual objects within the augmented reality environment 410. In some embodiments, if the virtual pointer points to (or overlays) a virtual or real-world object that is selectable, then the HMD may provide feedback to the end user that the object is selectable (e.g., a vibration, a sound, or a visual indicator may be used to alert the end user that additional information associated with the selectable object is available). In one embodiment, the initial position of the virtual pointer 32 within the augmented reality environment 410 may be determined based on a particular direction in which the end user is gazing.

FIG. 5 depicts one embodiment of an augmented reality environment 410 as seen by an end user wearing an HMD, such as mobile device 19 in FIG. 1. As depicted, the augmented reality environment 410 has been augmented with a virtual pointer 32, a virtual ball 25, and a virtual monster 27. The augmented reality environment 410 also includes a real-world object comprising a chair 16. In one embodiment, the initial position of the virtual pointer within the augmented reality environment may be determined based on a particular direction in which the end user is gazing and/or a particular object at which the end user is currently focusing on or has recently focused on. In some cases, the initial position of the virtual pointer 32 may be associated with a virtual object closest to a gazing direction of the end user. In other cases, the initial position of the virtual pointer 32 may be associated with a particular object (real or virtual) within the augmented reality environment 410 that has been focused on the most within a given period of time (e.g., within the last 30 seconds).

FIG. 6 depicts one embodiment of an augmented reality environment 410 as seen by an end user wearing an HMD, such as mobile device 19 in FIG. 1. As depicted, the augmented reality environment 410 has been augmented with a virtual pointer 32, a virtual ball 25, and a virtual monster 27. The augmented reality environment 410 also includes a real-world object comprising a chair 16. In one embodiment, a portion 26 of the augmented reality environment 410 may be enlarged (or zoomed into) based on a position of the virtual pointer 32. The zoomed-in portion 26 of the augmented reality environment 410 may be used in combination with the virtual pointer 32 in order to improve selection of real and/or virtual objects within the augmented reality environment 410. In some embodiments, control of the virtual pointer 32 may correspond with movements of a secondary device (e.g., a mobile phone or other device with the ability to provide motion and/or orientation information associated with the device to the HMD). In some cases, the secondary device may comprise an IMU enabled ring, watch, bracelet, or wristband which may provide motion and/or orientation information associated with arm, hand, and/or finger movements of the end user to the HMD.

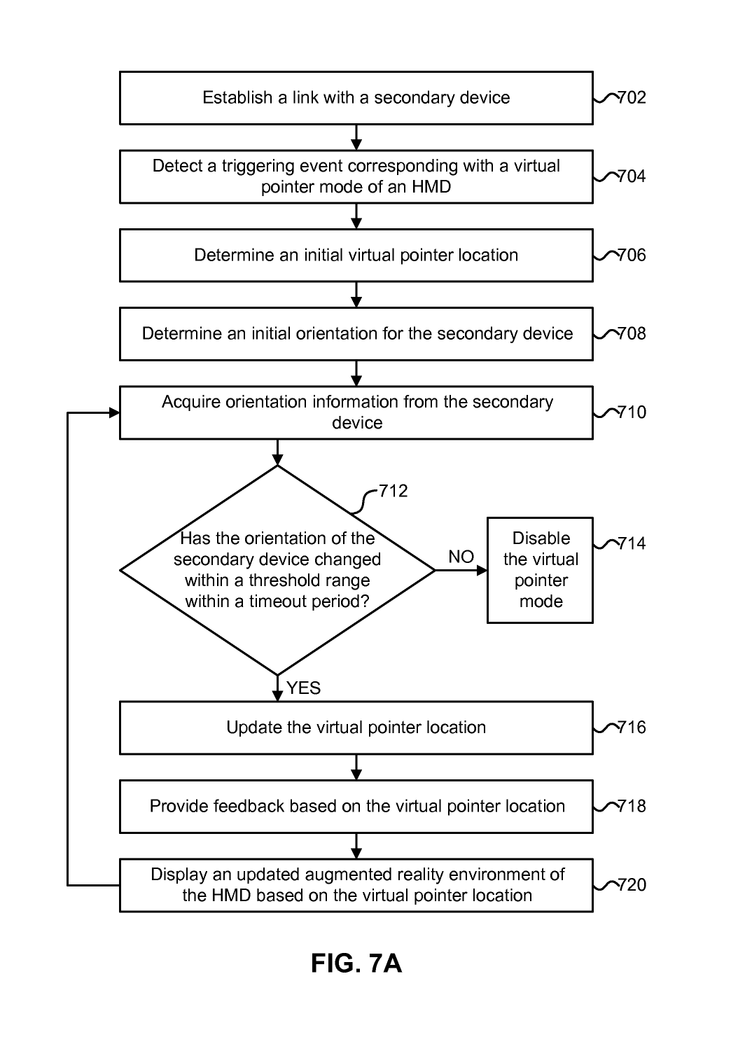

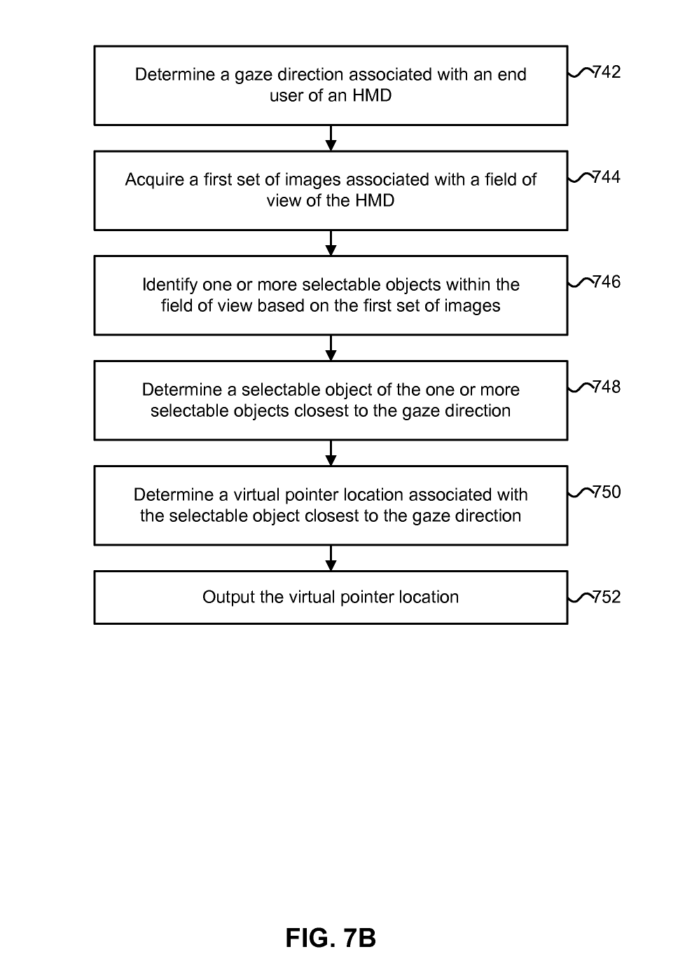

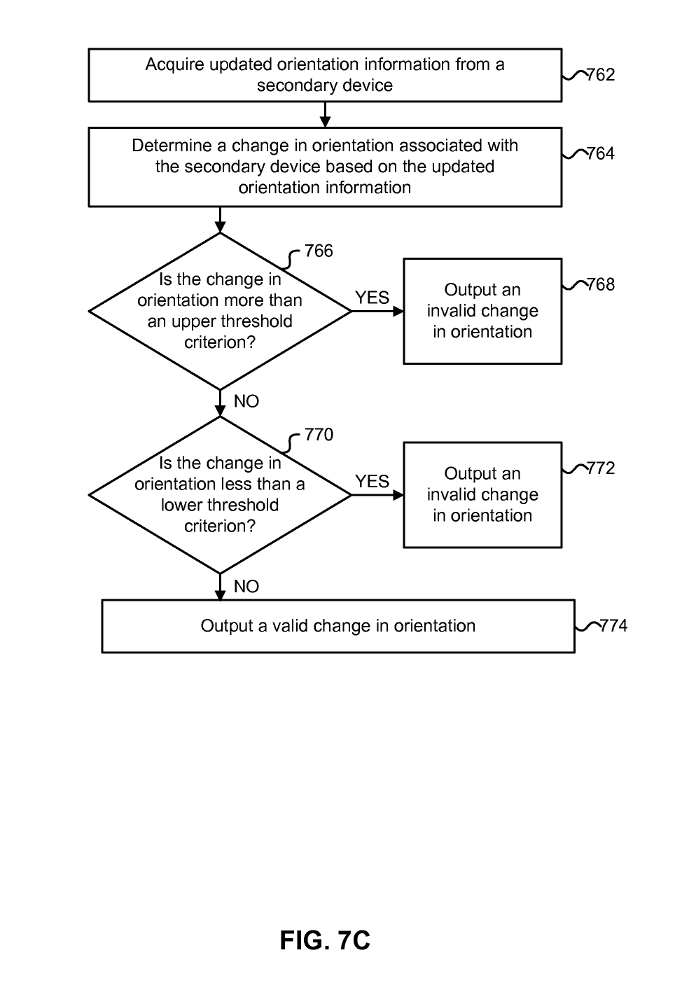

FIG. 7A is a flowchart describing one embodiment of a method for controlling an augmented reality environment using a secondary device. In one embodiment, the process of FIG. 7A may be performed by a mobile device, such as mobile device 19 in FIG. 1.

In step 702, a link between an HMD and a secondary device is established. The secondary device may comprise a mobile phone or other mobile device with the ability to provide motion and/or orientation information to the HMD (e.g., an IMU enabled ring or wristband). In one embodiment, the link may be established with a secondary device that has provided authentication credentials to the HMD. The HMD may be in communication with the secondary device via a wireless connection, such as a Wi-Fi connection or Bluetooth connection.

In step 704, a triggering event corresponding with a virtual pointer mode of the HMD is detected. The virtual pointer mode may allow an end user of the HMD to control a virtual pointer within an augmented reality environment provided to the end user of the HMD and to select and manipulate real objects and/or virtual objects within the augmented reality environment. A virtual pointer may comprise a virtual arrow, a virtual cursor, or a virtual guide that may be displayed to the end user within the augmented reality environment. In some cases, the virtual pointer may comprise the end of a virtual ray that is projected into the augmented reality environment.

In one embodiment, the triggering event may be detected upon the detection of a voice command from the end user (e.g., the end user saying “virtual pointer on”). In another embodiment, the triggering event may be detected upon the detection of a particular movement or gesture associated with a secondary device (e.g., the shaking of the secondary device). The triggering event may also be detected based on a combination of voice commands and physical movements (e.g., the pressing of a button on the secondary device) made by the end user of the HMD. In some cases, the triggering event may be detected upon the detection of the end user performing a particular gesture (e.g., a hand gesture associated with the virtual pointer mode).

In step 706, an initial virtual pointer location is determined. In one embodiment, the initial virtual pointer location may be determined based on a gaze direction of the end user (e.g., a particular region within an augmented reality environment in which the end user is looking). In another embodiment, the initial virtual pointer location may be determined based on a particular direction in which the end user is gazing and/or a particular object at which the end user is currently focusing on or has recently focused on (e.g., the particular object with which the end user has focused on most within the last 30 seconds). In some cases, more than one virtual pointer may be displayed to the end user, wherein each of the virtual pointers is associated with a different color or symbol. The end user may select one of the virtual pointer locations by issuing a voice command identifying one of the virtual pointers. One embodiment of a process for determining an initial virtual pointer location is described later in reference to FIG. 7B.

In step 708, an initial orientation for the secondary device is determined. In one embodiment, the initial orientation may be determined by the HMD based on orientation information provided to the HMD by the secondary device. Changes in orientation of the secondary device may subsequently be made relative to the initial orientation. In another embodiment, the initial orientation may be determined by the secondary device itself, in which relative orientation changes may be provided to the HMD. The initial orientation may correspond with an orientation relative to a reference frame provided by the HMD. In some cases, the HMD may reset or recalibrate the secondary device after a particular period of time (e.g., after 30 seconds) in order to correct for drift errors or accumulation errors in the orientation information transmitted from the secondary device to the HMD.

In step 710, updated orientation information is acquired from the secondary device. The orientation information may be transmitted to the HMD from the secondary device via a wireless connection. In step 712, it is determined whether the orientation of the secondary device has changed within a threshold range within a timeout period. If the orientation of the secondary device has changed within the threshold range within the timeout period, then step 716 is performed. Otherwise, if the orientation of the secondary device has not changed within the threshold range within the timeout period, then step 714 is performed. One embodiment of a process for determining whether the orientation of the secondary device has changed within a threshold range within a timeout period is described later in reference to FIG. 7C.

In step 714, the virtual pointer mode is disabled. In some cases, the virtual pointer mode may be disabled because the orientation change associated with the secondary device is outside the threshold range allowed for valid orientation changes. In one example, the orientation change may be more than that allowed by the threshold range because the end user has put the secondary device in their pocket and has started to walk or run. In another example, the orientation change may be less than the threshold range for more than a timeout period (e.g., two minutes) because the end user has set the secondary device on a table.

In step 716, the virtual pointer location is updated based on the change in orientation of the secondary device. In step 718, feedback based on the virtual pointer location is provided to the end user of the HMD. In one embodiment, the feedback may comprise haptic feedback. In one example, the feedback may comprise a vibration of the secondary device if the virtual pointer location is associated with a selectable object within an augmented reality environment. In another embodiment, the feedback may comprise a highlighting (or other visual indication) of a selectable object within an augmented reality environment if the virtual pointer location corresponds with a location or region associated with the selectable object. The feedback may also comprise an audio signal or sound (e.g., a beep) if the virtual pointer location overlays a selectable object within the augmented reality environment.

In step 720, an augmented reality environment of the HMD is updated based on the virtual pointer location. The updated augmented reality environment may be displayed to the end user via the HMD. In one embodiment, the augmented reality environment may be updated by moving the virtual pointer to the updated virtual pointer location. In another embodiment, the augmented reality environment may be updated by providing additional information associated with a selectable object within the augmented reality environment in response to a selection of the selectable object (e.g., via a shaking of the secondary device) and the virtual pointer location being within a region of the augmented reality environment associated with the selectable object. The additional information may be acquired from a supplemental information server, such as server 15 in FIG. 1. In some cases, as the virtual pointer (per the virtual pointer location) gets closer to a selectable object, the movement of the virtual pointer may be slowed down in order to improve selection accuracy. After step 720 is performed, step 710 is performed.

FIG. 7B is a flowchart describing one embodiment of a process for determining an initial virtual pointer location. The process described in FIG. 7B is one example of a process for implementing step 706 in FIG. 7A. In one embodiment, the process of FIG. 7B may be performed by a mobile device, such as mobile device 19 in FIG. 1.

In step 742, a gaze direction associated with an end user of an HMD is determined. The gaze direction may be determined using gaze detection techniques and may correspond with a point in space or a region within an augmented reality environment. In step 744, a first set of images associated with a field of view of the HMD is acquired. The first set of images may include color and/or depth images. The first set of images may be captured using a capture device, such as capture device 213 in FIG. 2B.

In step 746, one or more selectable objects within the field of view are identified based on the first set of images. The one or more selectable objects may be identified by applying object and/or image recognition techniques to the first set of images. The one or more selectable objects may include virtual objects (e.g., a virtual monster) and/or real-world objects (e.g., a chair). The one or more selectable objects may be associated with objects for which additional information may be acquired and displayed to the end user within the augmented reality environment. In some cases, the ability to select an object within an augmented reality environment may depend on a state of an application running on the HMD (e.g., application logic may only allow a selection of particular types of virtual objects when the application is in a particular state).

In step 748, a selectable object of the one or more selectable objects closest to the gaze direction is determined. In one embodiment, the selectable object comprises a virtual object associated with a location within an augmented reality environment that is closest to the gaze direction. In step 750, a virtual pointer location associated with the selectable object is determined. The virtual pointer location may correspond with a center point of the selectable object. In step 752, the virtual pointer location is outputted.

FIG. 7C is a flowchart describing one embodiment of a process for determining whether the orientation of the secondary device has changed within a threshold range within a timeout period. The process described in FIG. 7C is one example of a process for implementing step 712 in FIG. 7A. In one embodiment, the process of FIG. 7C may be performed by a mobile device, such as mobile device 19 in FIG. 1.

In step 762, updated orientation information is acquired from the secondary device. The secondary device may comprise a mobile phone or a handheld electronic device held by an end user of an HMD. In step 764, a change in orientation associated with the secondary device is determined based on the updated orientation information. In one embodiment, the change in orientation corresponds with a change in one or more Euler angles associated with an orientation of the secondary device.

In step 766, it is determined whether the change in orientation is more than an upper threshold criterion. In one embodiment, the upper threshold criterion may correspond with a change in orientation by more than 30 degrees within a 500 millisecond time period. If it is determined that the change in orientation is more than the upper threshold criterion, then step 768 is performed. In step 768, an invalid change in orientation is outputted (e.g., the change in orientation is considered excessive and not a reliable indication of a change in orientation). Otherwise, if it is determined that the change in orientation is not more than the upper threshold criterion, then step 770 is performed. In step 770, it is determined whether the change in orientation is less than a lower threshold criterion. In one embodiment, the lower threshold criterion may correspond with a change in orientation of less than 1 degree within a 50 millisecond time period. If the change in orientation is less than the lower threshold criterion, then step 772 is performed. In step 772, an invalid change in orientation is outputted (e.g., the change in orientation is considered noise and not a reliable indication of a change in orientation). Otherwise, if it is determined that the change in orientation is not less than the lower threshold criterion, then step 774 is performed. In step 774, a valid change in orientation is outputted. If a valid change in orientation is detected, then the change in orientation may be used to update a location of a virtual pointer within an augmented reality environment.

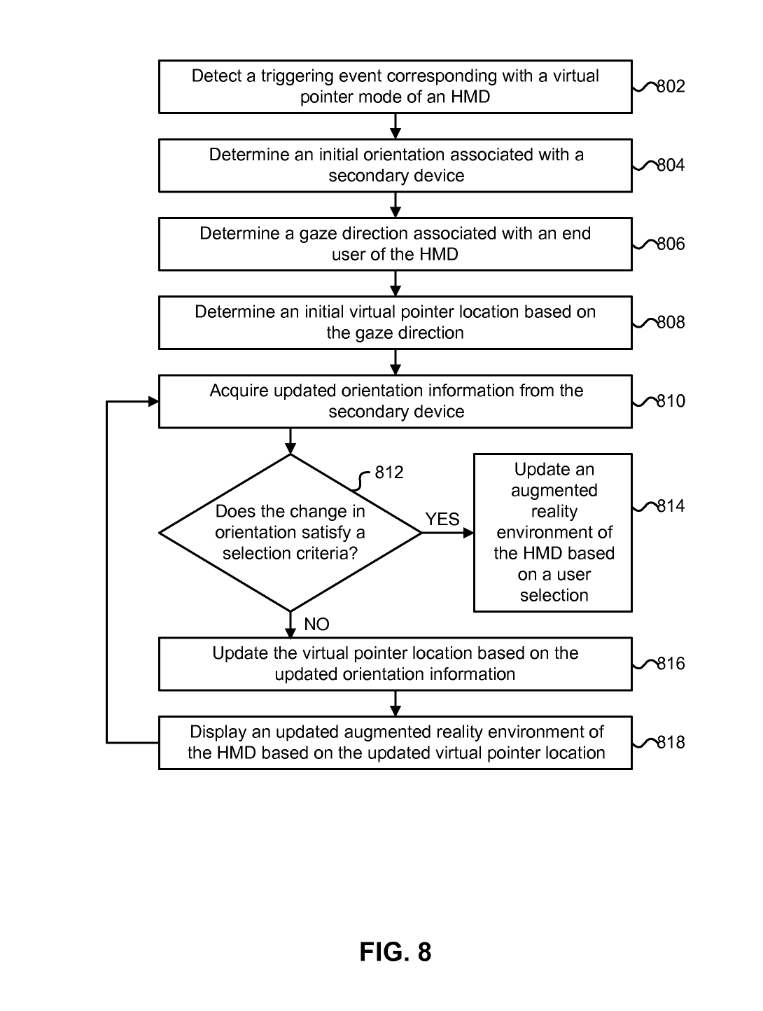

FIG. 8 is a flowchart describing an alternative embodiment of a method for controlling an augmented reality environment using a secondary device. In one embodiment, the process of FIG. 8 may be performed by a mobile device, such as mobile device 19 in FIG. 1.

In step 802, a triggering event corresponding with a virtual pointer mode of an HMD is detected. The virtual pointer mode may allow an end user of the HMD to control a virtual pointer within an augmented reality environment provided to the end user and to select and manipulate real and/or virtual objects within the augmented reality environment. A virtual pointer may comprise a virtual arrow, a virtual cursor, or a virtual guide that may be displayed to the end user within the augmented reality environment. In some cases, the virtual pointer may comprise the end of a virtual ray projected into the augmented reality environment.

In one embodiment, the triggering event may be detected upon the detection of a voice command from the end user (e.g., the end user saying “enable virtual pointer”). In another embodiment, the triggering event may be detected upon the detection of a particular movement or gesture associated with a secondary device (e.g., the shaking of the secondary device). The triggering event may also be detected based on a combination of voice commands and physical movements (e.g., the pressing of a button on the secondary device) made by the end user of the HMD. In some cases, the triggering event may be detected upon the detection of the end user performing a particular gesture (e.g., a hand gesture associated with the virtual pointer mode).

In step 804, an initial orientation associated with a secondary device is determined. In one embodiment, the initial orientation may be determined by the HMD based on orientation information provided to the HMD by the secondary device. Changes in orientation of the secondary device may subsequently be made relative to the initial orientation. In another embodiment, the initial orientation may be determined by the secondary device itself, in which relative orientation changes may be provided to the HMD. The initial orientation may correspond with an orientation relative to a reference frame provided by the HMD. In some cases, the HMD may reset or recalibrate the secondary device after a particular period of time (e.g., after 30 seconds) in order to correct for drift errors or accumulation errors in the orientation information transmitted from the secondary device to the HMD.

In step 806, a gaze direction associated with an end user of the HMD is determined. The gaze direction may be determined using gaze detection techniques and may correspond with a point in space or a region within an augmented reality environment. In step 808, an initial virtual pointer location is determined based on the gaze direction. In one embodiment, the initial virtual pointer location may be determined based on a gaze direction of the end user (e.g., towards a particular region within an augmented reality environment in which the end user is looking). In some cases, more than one virtual pointer may be displayed to the end user based on the gaze direction, wherein each of the virtual pointers is associated with a different color or symbol. The end user may select one of the virtual pointer locations by issuing a voice command identifying one of the virtual pointers (e.g., the blue arrow).

In step 810, updated orientation information is acquired from the secondary device. The updated orientation information may be transmitted to the HMD from the secondary device via a wireless connection. The orientation information may correspond with absolute orientation information or relative orientation information relative to a particular reference frame. In step 812, it is determined whether the change in orientation satisfies a selection criterion. In one embodiment, the selection criterion includes a shaking of the secondary device. In another embodiment, the selection criterion includes a particular change in orientation or sequence of changes in orientation (e.g., the end user moves their mobile device from a horizontal position to a vertical position back to the horizontal position within a three second time period). If it is determined that the change in orientation satisfies the selection criterion, then step 814 is performed.

In step 814, an augmented reality environment of the HMD is updated based on a user selection. The augmented reality environment may be updated based on both the user selection and a location of a virtual pointer location within the augmented reality environment. In one example, the end user may move the virtual pointer to a location corresponding with a selectable object within the augmented reality environment and perform a selection gesture (e.g., by shaking their mobile phone such that the selection criterion is satisfied). The combination of the virtual pointer location and the user selection may cause additional information associated with the selectable object to be acquired and displayed to the end user within the augmented reality environment.

Otherwise, if it is determined that the change in orientation does not satisfy the selection criterion, then step 816 is performed. In step 816, the virtual pointer location is updated based on the updated orientation information. In one embodiment, a virtual pointer sensitivity associated with a virtual pointer may be adjusted based on the virtual pointer location. In one example, the virtual pointer sensitivity (e.g., a rate at which changes in the orientation of the secondary device translate to changes in the virtual pointer location) may be reduced if the virtual pointer location comes within a particular distance of a selectable object. In step 818, an augmented reality environment of the HMD is updated based on the updated virtual pointer location. The updated augmented reality environment may be displayed to the end user via the HMD. The augmented reality environment may be updated in order to move and display an updated location of a virtual pointer within the augmented reality environment. After step 818 is performed, step 810 is performed.

One embodiment of the disclosed technology includes detecting a triggering event corresponding with a virtual pointer mode of an HMD, determining an initial virtual pointer location in response to the detecting a triggering event, acquiring orientation information from a secondary device in communication with the HMD, updating the virtual pointer location based on the orientation information, and displaying a virtual pointer within the augmented reality environment corresponding with the virtual pointer location.

One embodiment of the disclosed technology includes a memory, one or more processors in communication with the memory, and a see-through display in communication with the one or more processors. The memory stores an initial orientation associated with a secondary device in communication with the electronic device. The one or more processors detect a triggering event corresponding with a virtual pointer mode and determine an initial virtual pointer location in response to detecting the triggering event. The one or more processors acquire orientation information from the secondary device and update the virtual pointer location based on the orientation information and the initial orientation. The see-through display displays the augmented reality environment including a virtual pointer corresponding with the virtual pointer location.

One embodiment of the disclosed technology detecting a triggering event corresponding with a virtual pointer mode of an HMD, determining a gaze direction associated with an end user of the HMD, determining an initial virtual pointer location based on the gaze direction, acquiring updated orientation information from the secondary device, updating the virtual pointer location based on the updated orientation information, displaying a virtual pointer within the augmented reality environment corresponding with the virtual pointer location, determining that a selection criterion has been satisfied, and displaying an updated augmented reality environment based on the selection criterion and the virtual pointer location.

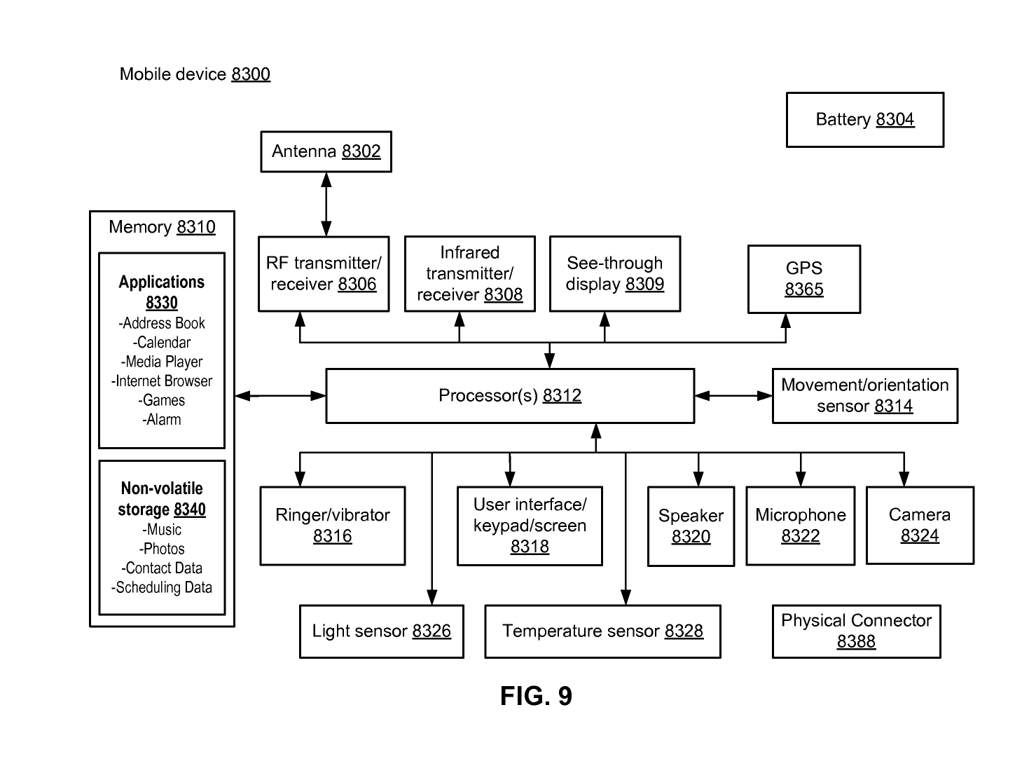

FIG. 9 is a block diagram of one embodiment of a mobile device 8300, such as mobile device 19 in FIG. 1. Mobile devices may include laptop computers, pocket computers, mobile phones, personal digital assistants, and handheld media devices that have been integrated with wireless receiver/transmitter technology.

Mobile device 8300 includes one or more processors 8312 and memory 8310. Memory 8310 includes applications 8330 and non-volatile storage 8340. Memory 8310 can be any variety of memory storage media types, including non-volatile and volatile memory. A mobile device operating system handles the different operations of the mobile device 8300 and may contain user interfaces for operations, such as placing and receiving phone calls, text messaging, checking voicemail, and the like. The applications 8330 can be any assortment of programs, such as a camera application for photos and/or videos, an address book, a calendar application, a media player, an internet browser, games, an alarm application, and other applications. The non-volatile storage component 8340 in memory 8310 may contain data such as music, photos, contact data, scheduling data, and other files.

The one or more processors 8312 are in communication with a see-through display 8309. The see-through display 8309 may display one or more virtual objects associated with a real-world environment. The one or more processors 8312 also communicates with RF transmitter/receiver 8306 which in turn is coupled to an antenna 8302, with infrared transmitter/receiver 8308, with global positioning service (GPS) receiver 8365, and with movement/orientation sensor 8314 which may include an accelerometer and/or magnetometer. RF transmitter/receiver 8308 may enable wireless communication via various wireless technology standards such as Bluetooth® or the IEEE 802.11 standards. Accelerometers have been incorporated into mobile devices to enable applications such as intelligent user interface applications that let users input commands through gestures, and orientation applications which can automatically change the display from portrait to landscape when the mobile device is rotated. An accelerometer can be provided, e.g., by a micro-electromechanical system (MEMS) which is a tiny mechanical device (of micrometer dimensions) built onto a semiconductor chip. Acceleration direction, as well as orientation, vibration, and shock can be sensed. The one or more processors 8312 further communicate with a ringer/vibrator 8316, a user interface keypad/screen 8318, a speaker 8320, a microphone 8322, a camera 8324, a light sensor 8326, and a temperature sensor 8328. The user interface keypad/screen may include a touch-sensitive screen display.

The one or more processors 8312 controls transmission and reception of wireless signals. During a transmission mode, the one or more processors 8312 provide voice signals from microphone 8322, or other data signals, to the RF transmitter/receiver 8306. The transmitter/receiver 8306 transmits the signals through the antenna 8302. The ringer/vibrator 8316 is used to signal an incoming call, text message, calendar reminder, alarm clock reminder, or other notification to the user. During a receiving mode, the RF transmitter/receiver 8306 receives a voice signal or data signal from a remote station through the antenna 8302. A received voice signal is provided to the speaker 8320 while other received data signals are processed appropriately.

Additionally, a physical connector 8388 may be used to connect the mobile device 8300 to an external power source, such as an AC adapter or powered docking station, in order to recharge battery 8304. The physical connector 8388 may also be used as a data connection to an external computing device. The data connection allows for operations such as synchronizing mobile device data with the computing data on another device.

The disclosed technology is operational with numerous other general purpose or special purpose computing system environments or configurations. Examples of well-known computing systems, environments, and/or configurations that may be suitable for use with the technology include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosed technology may be described in the general context of computer-executable instructions, such as program modules, being executed by a computer. Generally, software and program modules as described herein include routines, programs, objects, components, data structures, and other types of structures that perform particular tasks or implement particular abstract data types. Hardware or combinations of hardware and software may be substituted for software modules as described herein.

The disclosed technology may also be practiced in distributed computing environments where tasks are performed by remote processing devices that are linked through a communications network. In a distributed computing environment, program modules may be located in both local and remote computer storage media including memory storage devices.

For purposes of this document, each process associated with the disclosed technology may be performed continuously and by one or more computing devices. Each step in a process may be performed by the same or different computing devices as those used in other steps, and each step need not necessarily be performed by a single computing device.

For purposes of this document, reference in the specification to “an embodiment,” “one embodiment,” “some embodiments,” or “another embodiment” are used to described different embodiments and do not necessarily refer to the same embodiment.

For purposes of this document, a connection can be a direct connection or an indirect connection (e.g., via another part).

For purposes of this document, the term “set” of objects, refers to a “set” of one or more of the objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for controlling an augmented reality environment associated with an HMD, comprising:
detecting a triggering event corresponding with a virtual pointer mode of the HMD;
determining an initial virtual pointer location in response to the detecting a triggering event;
acquiring orientation information from a secondary device in communication with the HMD;
updating the virtual pointer location based on the orientation information; and
displaying a virtual pointer within the augmented reality environment corresponding with the virtual pointer location.

2. The method of claim 1, wherein:
the determining an initial virtual pointer location includes determining a gaze direction associated with an end user of the HMD and setting the initial virtual pointer location based on the gaze direction.

3. The method of claim 1, wherein:
the determining an initial virtual pointer location includes determining a gaze direction associated with an end user of the HMD, identifying one or more selectable objects within a field of view of the HMD, determining a selectable object of the one or more selectable objects closest to the gaze direction, and setting the initial virtual pointer location based on a location of the selectable object within the augmented reality environment.

4. The method of claim 3, further comprising:
providing feedback to the end user if the virtual pointer location corresponds with one or more regions within the augmented reality environment associated with the one or more selectable objects.

5. The method of claim 4, wherein:
the feedback includes a vibration of the secondary device.

6. The method of claim 1, further comprising:
determining whether a change in orientation of the secondary device is within a threshold range based on the orientation information, the updating the virtual pointer location is performed in response to the change in orientation of the secondary device being within the threshold range.

7. The method of claim 1, further comprising:
determining an initial orientation associated with the secondary device prior to the acquiring orientation information, the acquiring orientation information includes receiving relative orientation information relative to the initial orientation associated with the secondary device.

8. The method of claim 1, wherein:
the detecting a triggering event includes detecting a hand gesture associated with the virtual pointer mode performed by an end user of the HMD.

9. The method of claim 1, wherein:
the secondary device comprises a mobile phone.

10. An electronic device for displaying an augmented reality environment, comprising:
a memory, the memory stores an initial orientation associated with a secondary device in communication with the electronic device;
one or more processors in communication with the memory, the one or more processors detect a triggering event corresponding with a virtual pointer mode and determine an initial virtual pointer location in response to detecting the triggering event, the one or more processors acquire orientation information from the secondary device and update the virtual pointer location based on the orientation information and the initial orientation; and
a see-through display in communication with the one or more processors, the see-through display displays the augmented reality environment including a virtual pointer corresponding with the virtual pointer location.

11. The electronic device of claim 10, wherein:
the one or more processors determine the initial virtual pointer location by determining a gaze direction associated with an end user of the electronic device and setting the initial virtual pointer location based on the gaze direction.

12. The electronic device of claim 10, wherein:
the one or more processors determine the initial virtual pointer location by determining a gaze direction associated with an end user of the electronic device, identifying one or more selectable objects within a field of view of the electronic device, determining a selectable object of the one or more selectable objects closest to the gaze direction, and setting the initial virtual pointer location based on a location of the selectable object within the augmented reality environment.

13. The electronic device of claim 12, wherein:
the one or more processors provide feedback to the end user if the virtual pointer location corresponds with one or more regions within the augmented reality environment associated with the one or more selectable objects.

14. The electronic device of claim 13, wherein:
the one or more processors highlight the selectable object within the augmented reality environment if the virtual pointer location corresponds with the location of the selectable object.

15. The electronic device of claim 10, wherein:
the one or more processors detect a triggering event by detecting a hand gesture associated with the virtual pointer mode performed by an end user of the electronic device.

16. The electronic device of claim 10, wherein:
the electronic device comprises an HMD; and
the secondary device comprises a mobile phone.

17. One or more storage devices containing processor readable code for programming one or more processors to perform a method for controlling an augmented reality environment associated with an HMD comprising the steps of:
detecting a triggering event corresponding with a virtual pointer mode of the HMD;
determining a gaze direction associated with an end user of the HMD;
determining an initial virtual pointer location based on the gaze direction;
acquiring updated orientation information from a secondary device in communication with the HMD;
updating the virtual pointer location based on the updated orientation information;
displaying a virtual pointer within the augmented reality environment corresponding with the virtual pointer location;
determining that a selection criterion has been satisfied; and
displaying an updated augmented reality environment based on the selection criterion and the virtual pointer location.

18. The one or more storage devices of claim 17, wherein:
the determining an initial virtual pointer location includes identifying one or more selectable objects within a field of view of the HMD, determining a selectable object of the one or more selectable objects closest to the gaze direction, and setting the initial virtual pointer location based on a location of the selectable object within the augmented reality environment.

19. The one or more storage devices of claim 17, wherein:
the determining that a selection criterion has been satisfied includes determining that a change in orientation satisfies the selection criterion.

20. The one or more storage devices of claim 17, wherein:
the secondary device comprises a mobile phone.
